(19) United States
(12) Patent Application Publication
(10) Pub. No.: US 2023/0038057 A1
(43) Pub. Date: Feb. 9, 2023

(54) CONCENTRATED SURFACE TREATMENT PRODUCT AND METHOD OF PREPARING, PACKAGING AND APPLYING

(71) Applicant: SWIMC LLC, Cleveland, OH (US)

(72) Inventor: Andrew HEARLEY, Breda (NL)

(21) Appl. No.: 17/872,079

(22) Filed: Jul. 25, 2022

Related U.S. Application Data
(60) Provisional application No. 63/227,637, filed on Jul. 30, 2021.

(51) Int. Cl. C09D 15/00; C09D 7/61; C09D 7/63

(52) U.S. Cl. CPC C09D 15/00; C09D 7/61; C09D 7/63

(57) ABSTRACT

One or more systems, products, and methods are disclosed to provide for a concentrated surface treatment product, and the preparation, packaging, and application of the concentrated surface treatment product. The product can be easily stored, transported, and packaged in a variety of means while mitigating separation of the components of the surface treatment. The concentrated surface treatment product may be diluted using a solvent such as water by the end-user, allowing a user to mix only what is needed for the project and store the rest with less risk of separation than conventional surface treatments. The concentrated surface treatment may be packaged in a polymer pouch, a dissolvable solid, or in a spray nozzle, and when exposed to water, the concentrated surface treatment mixes and may be applied to a target surface.

### BACKGROUND

Consumers routinely apply surface treatment, which can include colorants, to products found around their home to treat or personalize the products. Traditional surface treatments for consumer use are heavy, difficult to transport, and require specific packaging for storage. Additionally, during storage the components of the surface treatment can separate, which can cause an uneven color and consistency of the surface treatment during application. Therefore, a method of preparing, packaging, and applying a surface treatment product that is lighter, easier to transport, and allows for more diverse packaging solutions while mitigating separation of the components of the surface treatment is desirous.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein are provided for a concentrated surface treatment product, that can be used to help prepare, package, and apply a concentrated surface treatment product. In one implementation a water-soluble concentrated surface treatment product that is operably mixed with water is disclosed comprising a combination of clay, modified acrylic, a defoamer, a microbiocide, xanthan gum, a polyethylene wax, a dye, a coalescent, and a rheology modifier.

In another implementation, a water-soluble surface treatment product that is operably mixed with water is disclosed, wherein the surface treatment product is disposed in a pre-measured, water-dissolvable polymer packet, the surface treatment product comprising a combination of clay, vinyl esters, a defoamer, a microbiocide, xanthan gum, a polyethylene wax, a dye, a coalescent, and a rheology modifier.

In yet another implementation, a method for applying a water-soluble surface treatment product that is operably mixed with water is disclosed, wherein the surface treatment produce comprises a combination of clay, vinyl esters, a defoamer, a microbiocide, xanthan gum, a polyethylene wax, a dye, a coalescent, and a rheology modifier, the method comprising disposing a predetermined amount of the concentrated surface treatment product in a predetermined amount of water, mixing the concentrated surface treatment product and water resulting in a desired liquid application surface treatment, and applying the liquid application surface treatment to a target surface.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is flow chart illustrating an exemplary implementation of a method of preparing a concentrated surface treatment product.

FIG. 2 is a flow chart illustrating an exemplary implementation of a method of applying a surface treatment product.

FIGS. 3A and 3B are component diagrams illustrating implementations of examples of one or more products described herein.

FIG. 4 is a component diagram illustrating implementations of examples of one or more products described herein.

FIG. 5 is a component diagram illustrating various implementations of example products described herein.

FIG. 6 is a component diagram illustrating one implementation of an example product described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As described herein, an environmentally friendly, sustainable, water-based, low VOC, surface treatment product (e.g., stain, dye, coating, etc.) can be developed in a ready mix colorant or tintable base, along with any appropriate tintable color. The surface treatment product can be provided in a concentrated form that can be mixed/diluted with an appropriate solvent, such as water, by the end user. The resulting concentrated surface treatment can be in the form of a dry or wet product, such as a powder, solid, gel or liquid, and provided in a variety of packaging (e.g., soft pack, cardboard box, dissolvable tablets (e.g., PVOH)/blocks, liquid capsules etc.). The surface treatment product can be mixed directly with the solvent and applied with a brush, roller, or spray, and/or mixed and applied with an in-line applicator. By proving a concentrated form of the surface treatment, packaging may be reduced, and transportation and storage may be easier due to the absence of the solvent that is later mixed by the end-user.

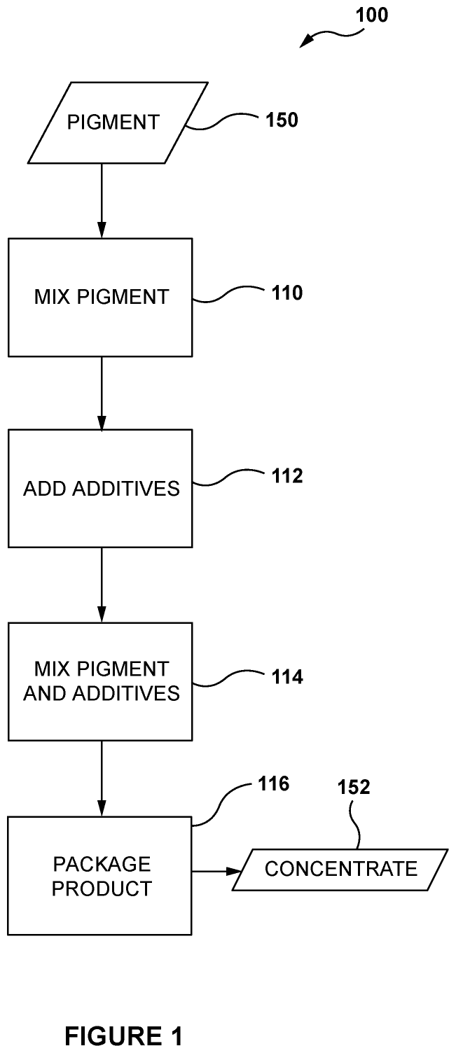

FIG. 1 illustrates one implementation of a method 100 for preparing a surface treatment product. In one implementation, the surface treatment product is a wood stain (e.g., a type of colorant that can include pigments that soak into wood fibers), however the surface treatment product may also be a paint (e.g., a colorant that after application converts to a solid film), a sealant (e.g., a material that seals a product to make it watertight, which can also be toned with a colorant), or a varnish (e.g., a material that after application forms a hard, transparent surface, that can be toned with a colorant). In one implementation, the surface treatment is prepared by mixing 110 pigment or dye 150, adding additives 112, mixing the pigment or dye with the additives 114, and packaging the surface treatment product 116 in such a manner to form a concentrate 152. Here, a pigment is not soluble within the product, while a dye is soluble within the product. The pigment may be organic or inorganic, colored or white, natural, natural or synthetic, or opaque or non-opaque. The pigment or dye may be mixed using any suitable means, such as an agitator, a blender, a paddle mixer, a static mixer, an emulsifier, a homogenizer, or a drum mixer. The mixing may be continuous or batch.

Additives may improve the properties of the pigment or dye, such as improving the substrate wetting, adding slip to the pigment or dye surface, making the pigment or dye fire-resistant, and/or improving the overall performance of the pigment or dye. The additives may be mixed 114 using any suitable means, such as an agitator, a blender, a paddle mixer, a static mixer, an emulsifier, a homogenizer, or a drum mixer. The mixing may be continuous or batch. In some implementations, the surface treatment product may be prepared as a base concentrate, without pigments or dyes. In these implementations, pigments or dyes may be included in a tint or colorant product that can be added later, such as in a retail setting where the consumer selects a desired color, and the tint is added to match that color.

In one implementation, the surface treatment is packaged at 116 as a wet product. Here, “wet” means in fluid-form such as a liquid or gel. The wet surface treatment may be highly concentrated 152, containing a high concentration of solute to solvent (pigment/dye/additives to water). Here, a high concentration may be 1:0.1-1:1 (ratio of solute to solvent). In one implementation, the concentrated surface treatment 152 may include clay, a modified acrylic (e.g., vinyl esters), a defoamer, a preservative (e.g., microbiocide), xanthan gum, a polyethylene wax, a dye, a coalescent, and a rheology modifier; and may include pigment or dye and additives. In another implementation, the concentrated surface treatment 152 may further include propylene glycol and/or ammonia. The clay may be anything suitable, such as synthetic smectite clay. The vinyl esters may be anything suitable, such as vinyl esters of versatic acid (VeoVa) disposed in a water-based dispersion. The defoamer may be anything suitable, such as a mineral-oil based defoamer. The mineral-oil based defoamer may further contain hydrocarbons and non-ionic surfactants. The preservative may be anything suitable, such as a mixture of 5-chloro-2-methyl-4-isothiazolin-3-one, and 2 methyl-4-isothiazolin-3-one; or 1,2-Benzisothiazolin-3-one. The polyethylene wax may be anything suitable such as an aqueous anionic or non-ionic emulsion. The coalescent may be anything suitable, such as an ester alcohol. The rheology modifying may be anything suitable, such as an alkali thickener (e.g., a swellable synthetic alkali, or resin).

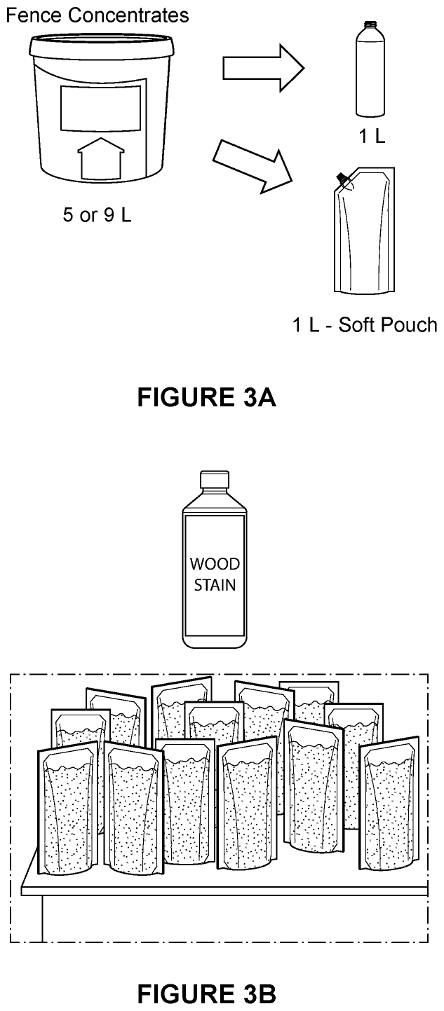

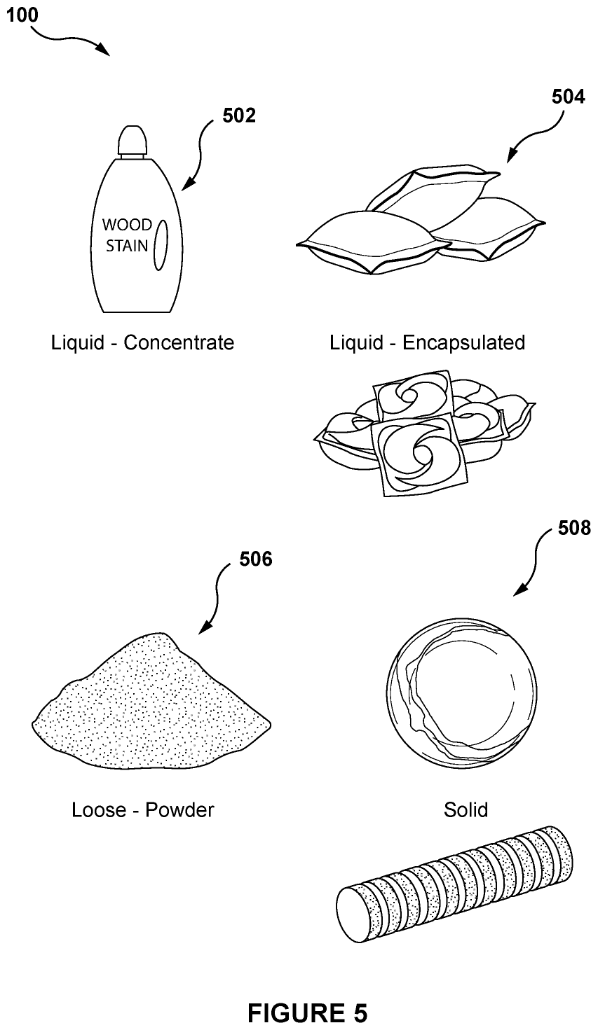

The wet surface treatment may be packaged at 116 using any suitable means. For example, as shown in FIGS. 3A, 3B and 5 (ref. 502) the packaging may be a bottle, jar, jug, pouch, etc. The packaging may be made of anything suitable such as glass or plastic (such as polyethylene, polyvinyl chloride, high-density polyethylene, or a water-dissolvable polymer). It should be appreciated that other packaging materials may be used. The packaging may further be resealable to allow for any unused wet concentrated surface treatment product 152 to be resealed for later use. Further, the wet surface treatment may be packaged or encapsulated in water dissolvable pouches, in gel or liquid form, such as those shown in FIG. 5 (ref 504). In some implementations, where the surface treatment is a tintable base, a wide-mouthed container may be used, to accommodate the appropriate addition of colorant by/for the consumer. In these implementations, the opening can be large enough to comfortable accommodate tint mixing machines, and may include a selectably removable cover (e.g., a screw top).

In another implementation, the surface treatment is packaged at 116 as a dry product. Here, “dry” means solid or powder. In one implementation the dry surface treatment may be mixed with dry pigment or dye and dry additives to highly concentrated dry surface treatment product 152. Here, a high concentration may be 1:0.01-0.1 (ratio of dry concentrate to moisture). In one implementation, the dry surface treatment concentrate 152 may include clay, vinyl esters, a defoamer, a microbiocide, xanthan gum, a polyethylene wax, a dye, a coalescent, and a rheology modifier. In another implementation, the concentrated surface treatment 152 may further include propylene glycol and/or ammonia. The clay may be anything suitable, such as synthetic smectite clay. The modified acrylic may be anything suitable disposed in a water-based dispersion, such as vinyl esters of versatic acid (VeoVa), for example, Xynpol A0577L is a VeoVa (VV)-Acrylic (AA) resin. The defoamer may be anything suitable, such as a mineral-oil based defoamer. The mineral-oil based defoamer may further contain hydrocarbons and non-ionic surfactants. The microbiocide may be anything suitable, such as a mixture of 5-chloro-2-methyl-4-isothiazolin-3-one and 2 methyl-4-isothiazolin-3-one; or 1,2-Benzisothiazolin-3-one. The polyethylene wax may be anything suitable such as an aqueous anionic or non-ionic emulsion. The coalescent may be anything suitable, such as an ester alcohol. The rheology modifying may be anything suitable, such as swellable synthetic alkali. In another implementation, wet surface treatment as disclosed in a previous implementation may be dehydrated, removing moisture from the wet surface treatment and producing a dry surface treatment. In another implementation, for a powder or solid form, the ingredients can be blended dry and then either packed into a box, or formed in a solid by pressing into a tablet/ball etc., for example. As an example, the resin can be spray dried and “dehydrated”, and the pigment portion is already disposed in powder form.

In some implementations, in the powdered or powdered-solid option, a 1K cross-linkable (e.g., di-acetoneacrylamide—DAAM or acetylacetoxymethylmethacrylate—AAEM) re-dispersible resin powder can be used. Further, in these implementations, a X-FAST powder pigment, a powder thickener, a powder defoamer (e.g., in the case of DAAM as the resin-Adipic dihydrazide) blend can be used. As an example, the resin cross-linking may be used to overcome the re-dispersibility issues of resins, and overcome water sensitivity of resins. In these implementations, a powder form resin that has these properties will improve dispersion.

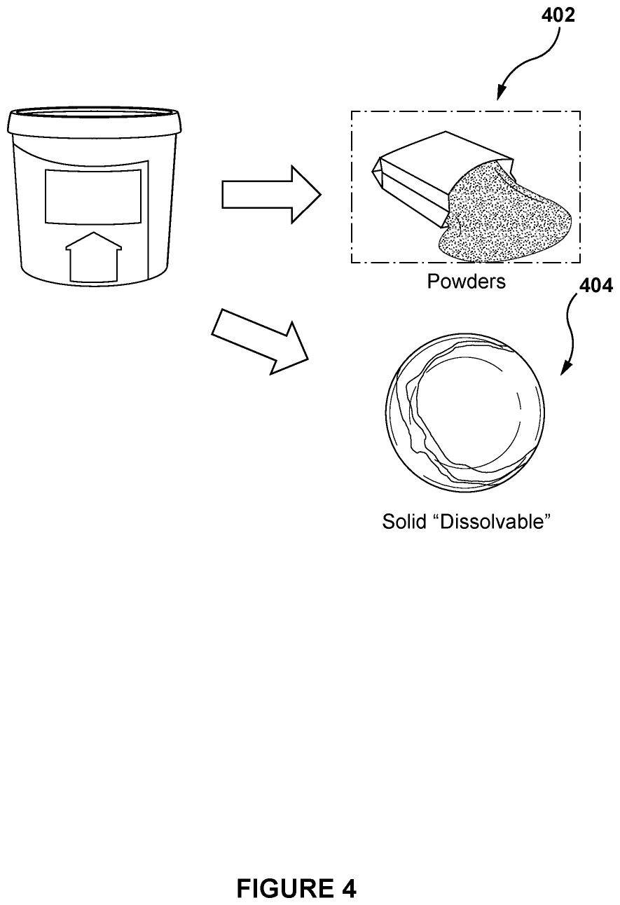

The dry surface treatment may be packaged at 116 using any suitable means. For example, as shown in FIGS. 4 (ref. 402 powder, ref. 404 solid) and 5 (ref. 506 powder, ref. 508 solid), the packaging may be a sack, or preformed solid, where the powdered dry surface treatment has been shaped into a semi-permanent solid object using pressure. The packaging may be made of anything suitable such as paper (e.g., or any other suitable bio material, such as cellulosic or protein/peptide, or saccharide/carbohydrate derived materials) or plastic (such as polyethylene, polyvinyl chloride, high-density polyethylene, or a water-dissolvable polymer). It should be appreciated that other packaging materials may be used. The packaging may further be resealable to allow for any unused wet concentrated surface treatment to be resealed for later use.

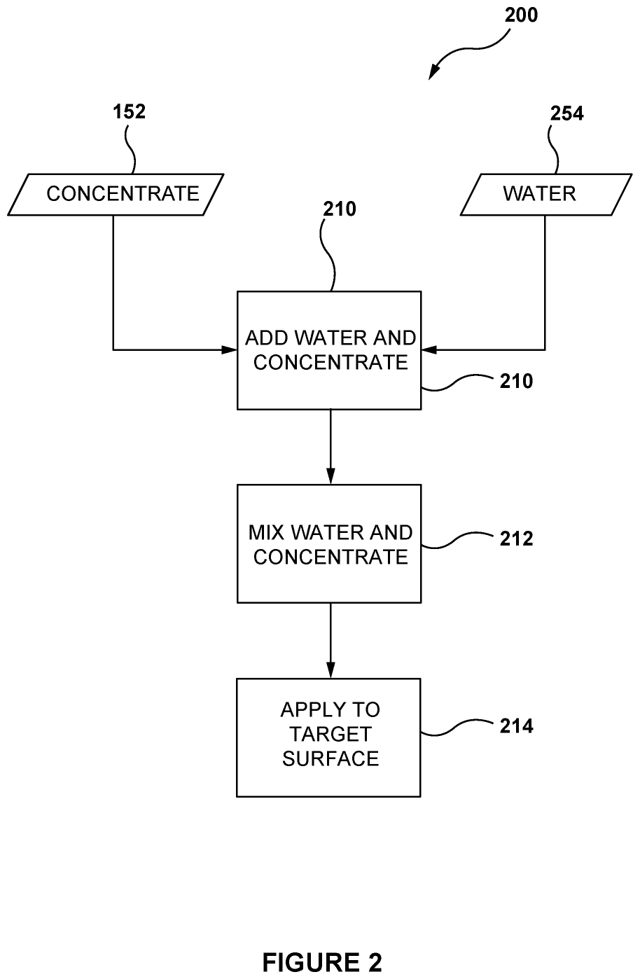

Referring now to FIG. 2, the end-use surface treatment product may be prepared and used 200 by adding the concentrated surface treatment product (wet or dry), at 210, to any suitable solvent, such as water 254, and mixing the water with the surface treatment concentrate, at 212. The water 254 may be ionized, deionized, tap, etc. For dry powders, the water may also be mixed with powdered acrylic, vinyl acrylics, styrene acrylic, etc. In one implementation the concentration of the solute to solvent may be 1:1, 1:2, 1:3, 1:4, 1:5, 1:6, 1:7, 1:8, 1:9, 1:10, 1:11, 1:12, or 1:13. The diluted surface treatment may now be applied to the target surface, at 214.

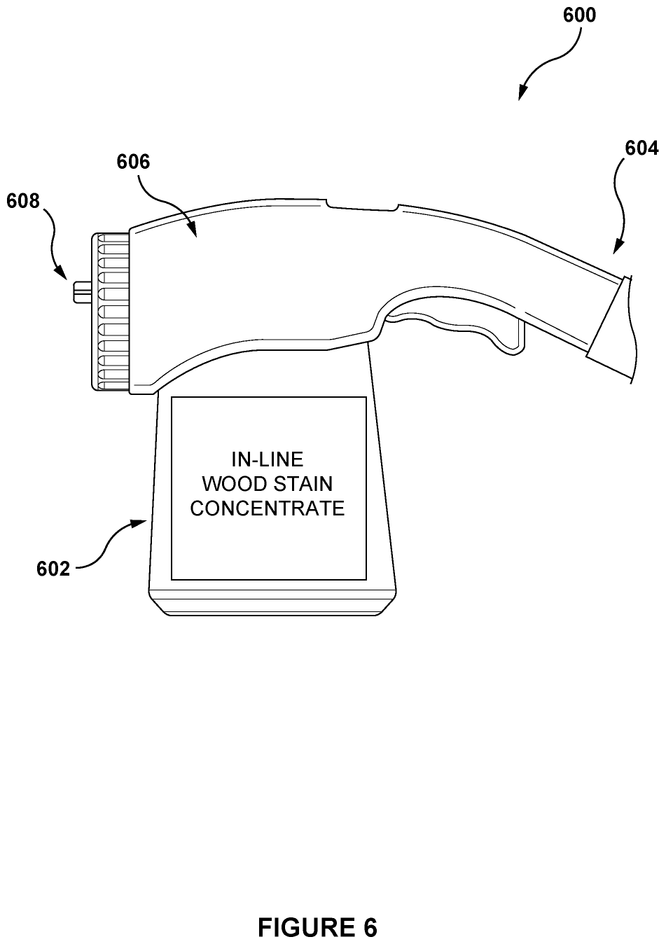

The prepared surface treatment may be mixed with water 254, at 212, using any suitable means. In one implementation, the mixing may occur by simply stirring the concentrated surface treatment 152 with the water 254. In another implementation, the mixing may occur using an in-line mixing and dispersal device, similar to that shown in FIG. 6, where a supply line 604 (e.g., water hose) connects to a device 600 that holds the concentrate 602 in storage, in wet or dry form. In this implementation, and as water is introduced through the supply line 604, the water mixes with the concentrate 602 in a mixing chamber 606, in appropriate metered amounts, and the diluted surface treatment exits through an outlet end 608, such as a spray nozzle. While the diluted surface treatment may be applied through spraying, it may also be applied by any other suitable means, such as rolling or brushing, or any other suitable means.

In one implementation, the concentrated surface treatment product can comprise the following components, in varying ranges:

| | % in product | |
|---|---|---|
| Component | Range (e.g.,) | |
| WATER | 0.1-60 | (13) |
| LAPONITE | >0-5 | (0.14) |
| XYNPOL A0577L | 10-40 | (25) |
| FOAMASTER MO2134 | >0-5 | (0.4) |
| ACTICIDE MV | >0-5 | (0.1) |
| ACTICIDE BCL2 | >0-5 | (0.4) |
| XANTHAN GUM | >0-5 | (1) |
| AQUACER 512 | >0-10 | (3.5) |
| TINT DISPERSION | 0.1-30 | (17.5) |
| ACTICIDE MKB5 | >0-5 | (0.23) |
| PROPYLENE GLYCOL | >0-5 | (1.7) |
| TEXANOL | >0-5 | (1.5) |
| VISCOATEX 730 | >0-5 | (0.5) |
| AMMONIA | >0-5 | (0.2) |

As an illustrative example, fences, decks, and other wood structures are often made of a softwood material. Typically, the types of wood products used for these projects are pre-treated for outdoor use, and without surface treatment may last from 10-15 years. Over time, the initial yellow/green color matures to a grey/silver color. Color stains or dyes can be applied for merely decorative purposes, and are provided in a ready-to-apply formulation, pre-mixed in a solvent such as water, latex, oil, alkyds, and other appropriate solvents.

As described herein, a concentrated surface treatment product, such as a liquid, gel, powder, or solid, can be delivered in a variety of packing. The concentrated product can be mixed with an appropriate solvent by the end user, for example, where one liter of concentrate can make five liters of a ready to apply surface treatment. Further, for example, the concentrated surface treatment product can be tintable, or provided in a ready-mix (e.g., pre-tinted) formulation. The concentrated product can be diluted with a solvent, such as ordinary tap water, either in a bucket or other suitable receptacle, and applied with brush, roller, sprayer, or in-line mixing applicator. In some examples, a loose powder form of the concentrate product may be dissolved in a solvent, where the powder is made from powdered acrylic, vinyl acrylics, styrene acrylic (e.g., that are spray dried). In some examples, powders that have been formed in dissolvable blocks or balls (e.g., bath bomb-style) can be added to water, or other appropriate solvent, to create a low build stain.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter comprises been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure comprises been shown and described with respect to one or more implementations, equivalent alterations and modifications will occur to others skilled in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “comprises,” “having,” “comprises,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A water-soluble concentrated surface treatment product that when mixed with water results in a ready-to-apply surface treatment coating, comprising a combination of:
clay;
modified acrylic;
a defoamer;
a preservative;
xanthan gum;
a polyethylene wax;
a coalescent; and
a rheology modifier.

2. The water-soluble concentrated surface treatment product of claim 1, comprising a dye.

3. The water-soluble concentrated surface treatment product of claim 1, the clay comprising a synthetic smectite clay.

4. The water-soluble concentrated surface treatment product of claim 1, the modified acrylic comprising a vinyl ester, wherein the vinyl ester is disposed in a water-based dispersion.

5. The water-soluble concentrated surface treatment product of claim 1, the defoamer comprising a mineral-oil based defoamer comprising hydrocarbons and non-ionic surfactants;

6. The water-soluble concentrated surface treatment product of claim 1, the preservative comprises a microbiocide comprising one or more of:
a mixture of 5-chloro-2-methyl-4-isothiazolin-3-one and 2-methyl-4-isothiazolin-3-one; and
1,2-Benzisothiazolin-3-one.

7. The water-soluble concentrated surface treatment product of claim 1, the polyethylene wax comprising an aqueous anionic/non-ionic emulsion.

8. The water-soluble concentrated surface treatment product of claim 1, the coalescent comprising an ester alcohol.

9. The water-soluble concentrated surface treatment product of claim 1, the rheology modifier comprising a swellable synthetic alkalie.

10. The water-soluble concentrated surface treatment product of claim 1, comprising propylene glycol.

11. The water-soluble concentrated surface treatment product of claim 1, comprising ammonia;

12. A water-soluble concentrated colorant product in liquid form that is operably mixed with water, formed from the product of claim 1.

13. A water-soluble concentrated surface treatment product in powder form that is operably mixed with water, formed from the product of claim 1.

14. A water-soluble concentrated surface treatment product in gel form that is operably mixed with water, formed from the product of claim 1.

15. A water-soluble concentrated surface treatment product in solid form that is operably mixed with water, formed from the product of claim 1, wherein the solid form is formed by applying a predetermined amount of pressure to a powdered form of the surface treatment product at least until the solid form is created.

16. A concentrated surface treatment product, comprising:
a powder that readily mixes with water to form a liquid, ready-to-use wood treatment product that preserves and colors a wood surface.

17. The water-soluble concentrated surface treatment product of claim 16, comprising one or more of:
clay;
vinyl esters;
a defoamer;
a microbiocide;
xanthan gum;
a polyethylene wax;
a dye;
a coalescent; and
a rheology modifier.

18. A method for applying a water-soluble concentrated surface treatment product that is operably mixed with water, wherein the surface treatment product comprising a combination of clay, vinyl esters, a defoamer, a microbiocide, xanthan gum, a polyethylene wax, a dye, a coalescent, and a rheology modifier, the method comprising:
disposing a predetermined amount of the concentrated surface treatment product in a predetermined amount of water;
mixing the concentrated surface treatment product and water resulting in a desired liquid application surface treatment; and
applying the liquid application surface treatment to a target surface.

19. The method of claim 18, using an in-line application device, wherein:
the disposing comprises dispensing a metered amount of the concentrated surface treatment product in water, in-line as the water is being released by the device;
the mixing comprises the concentrate and water automatically mixing inside the device resulting in a desired mixture of water and concentrated surface treatment product being dispersed from the device.

20. The method of claim 18, wherein a pre-measured solid form of the concentrated surface treatment product is placed in the water and mixed at least until the desired liquid application surface treatment results.
